(19) United States
(12) Patent Application Publication
(10) Pub. No.: US 2009/0272276 A1
(43) Pub. Date: Nov. 5, 2009

(54) INFUSION MAKER

(76) Inventors: YU-MEI LIN TIEN, Taipei City (TW); PAO-WU TIEN, Taipei City (TW)

Correspondence Address: LEONG C LEI, PMB # 1008, 1867 YGNACIO VALLEY ROAD, WALNUT CREEK, CA, 94598, US

(21) Appl. No.: 12/425,409

(22) Filed: Apr. 17, 2009

(30) Foreign Application Priority Data
Apr. 30, 2008 (TW) 097115844

(51) Int. Cl. A47J 31/06

(52) U.S. Cl. 99/298

(57) ABSTRACT

An infusion maker which includes a hollow body member having a surrounding flange and a through hole at the bottom and a hinged cover at the top; a filter member inside the body member covering the through hole; a blocking element for blocking the through hole; and an engaging member configured under the body member capable of moving up and down relative to the body member. The cover has a guiding plate for guiding condensed water drops to flow back into the body member. The blocking element tightly rests on a sleeve element at the through hole of the body member. The flange has a larger diameter than that of the engaging member and has a number of foot rests so as to protect the engaging member and to stably support the body member.

### (a) TECHNICAL FIELD OF THE INVENTION

The present invention generally relates to an infusion maker, and more particularly to one capable of guiding condensed water drops, preventing leakage, and standing reliably.

### (b) DESCRIPTION OF THE PRIOR ART

Coffee or tea drinking is widely popular among people's social life. Coffee houses or tea houses therefore could be found almost anywhere. To save time and effort, various coffee or tea makers are designed and marketed. However, they are all pretty much inconvenient to operate or complicatedly structured.

FIG. 8 shows a conventional infusion maker where a cover 91 is hinged to a handle 92 at a side of the body 90 that could be flipped open or close. When hot water is poured or stored inside the body 90, water drops would condense on the inner surface of the cover 91. When the cover 91 is opened, these water drops would drip to the handle 92 and further onto, for example, the table top.

Most conventional infusion makers have a filter screen tightly stuck along the inner surface of the body thereof. The filter screen is therefore difficult to take down for cleaning and reinstall. The infusion makers also often lack the configuration of air vent, and the fluid would not smoothly flow through the filter screen as there is no convection.

Please refer to People's Republic of China Patent No. ZL97116221.2 and Republic of China Patent No. 351971. The infusion makers from these teachings all have an engaging disc at the bottom of the body and the engaging disc has a larger diameter than the body. The engaging disc is therefore not protected by any mechanism. The engaging disc could then be accidentally triggered to release the fluid in the body. These infusion makers also have a number of stands at the bottom of the body for supporting the body that protrude through the engaging disc. These stands constitute a plane smaller than the area of the engaging disc and, therefore, the infusion maker is not quite stable and could easily tilt to a side. In addition, the stands' protrusion through the engaging disc is more complicated to manufacture.

There are some additional disadvantages for People's Republic of China Patent No. ZL97116221.2 and Republic of China Patent No. 351971. The covers of the infusion makers are not joined to the body and therefore could easily get misplaced. When pouring hot water into the body, as the user has to directly open the cover manually, there is a high possibility to burn the user's hand. Also as there is not any guiding mechanism, the condensed water drops on the cover would drip all over the table top.

### SUMMARY OF THE INVENTION

Accordingly, the present invention provides a novel infusion maker capable of guiding condensed water drops, preventing leakage, and standing reliably. Structurally, the infusion maker contains a hollow body member having a surrounding flange and a through hole at the bottom and a hinged cover at the top; a filter member inside the body member covering the through hole; a blocking element for blocking the through hole; and an engaging member configured under the body member capable of moving up and down relative to the body member. The cover has a guiding plate for guiding condensed water drops to flow back into the body member. The blocking element tightly rests on a sleeve element at the through hole of the body member. The flange has a larger diameter than that of the engaging member and has a number of foot rests so as to protect the engaging member and to stably support the body member.

The filter member has an air pipe for easy grasping and for providing convection to facilitate the flow of drinks in the body member.

The sleeve element has a circular groove to form a circular wall around the sleeve element's through hole so that the circular wall could tightly join to the blocking element.

The cover has a ventilation hole.

A handle is provided to a side of the body member. The handle has a pair of supporting elements to support a pivot to which the cover is hinged.

The filter member has a positioning tube at the bottom for positioning the blocking element right at the through hole of the body member.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an infusion maker according to an embodiment of the present invention.

FIG. 2 is a perspective break-down diagram showing the various components of the infusion maker of FIG. 1.

FIG. 3 is a sectional diagram showing the infusion maker of FIG. 1.

FIG. 4 is a sectional diagram showing the infusion maker of FIG. 1 when it is placed on a container.

FIG. 5 is a perspective diagram showing a sleeve element of the infusion maker of FIG. 1.

FIG. 6 is a sectional diagram showing the sleeve element of FIG. 5.

FIG. 7 is a perspective diagram showing condensed water drops flow back into the body member of the infusion maker of FIG. 1.

FIG. 8 is a perspective diagram showing a conventional infusion maker.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

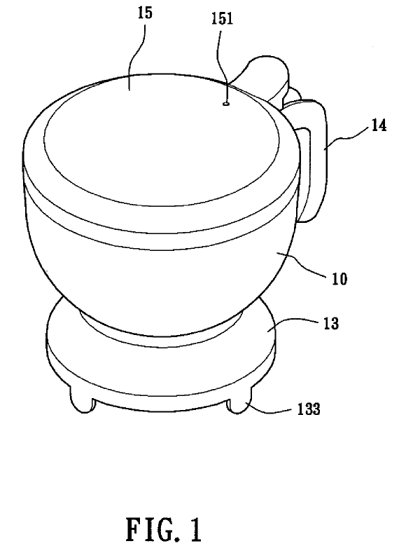

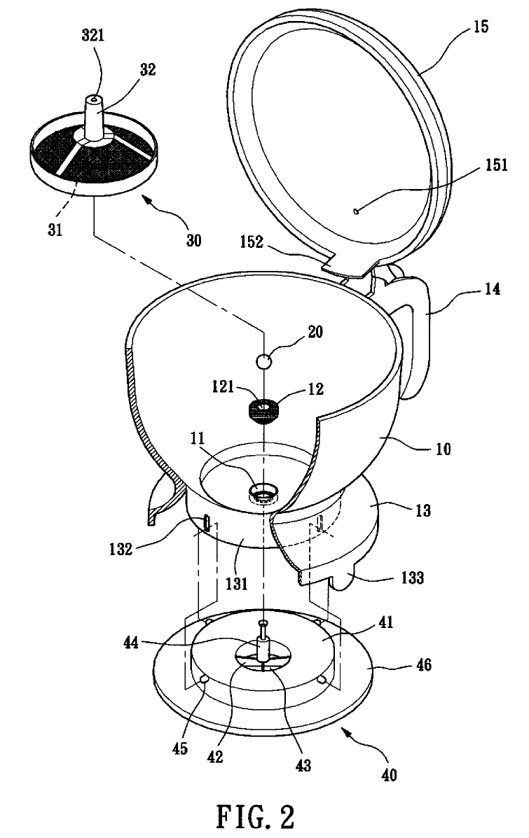

As shown in FIGS. 1 to 3, an infusion maker according to an embodiment of the present invention mainly contains a body member 10 made of a food-grade plastic material, a blocking element 20, a filter member 30, and an engaging member 40.

The body member 10 is hollow so as to hold coffee grounds or tea leaves or other objects for making drinks. A through hole 11 is provided at the bottom of the body 10 and the inner wall of the body member 10 is configured to slant towards the through hole 11 so as facilitate fluid's flowing to the through hole 11. A flange 13 is provided at the bottom surrounding the body member 10. Inside the flange 13, there is a co-centric ring wall 131 and, around the ring wall 131, there are a number of equal-spacing vertical slots 132. To a side of the body member 10, a handle 14 for easy grasping is provided. A pair of support elements 142 is raised on a top side of the handle 14 where a pivot 142 is supported therebetween. A cover 15 is hinged to the pivot 142 and therefore could be opened or closed. The cover 15 has a ventilation hole 151.

The blocking element 20 is positioned inside the body member 10 to block the through hole 11. Unless the blocking element 20 is engaged, the fluid inside the body member 10 is prevented from flowing through the through hole 11.

The filter member 30 is positioned inside the body member 10 and has a bulging shape covering the through hole 11. Therefore, fluid has to flow through and thereby screened by the filter member 30 before entering the through hole 11. At the center of the filter member 30, an air pipe 32 and a positioning tube 31 are aligned and extended vertically above and below the filter member 30, respectively. The air pipe 32 has a through channel with a top opening 321 and a bottom end connected to the positioning tube 32. The positioning tube 32 is configured such that its bottom openings holds the blocking element 20 right at the through hole 11.

The engaging member 40 has a up-side-down disc shape with an upward bulging, hollow, and circular seat element 41 surrounded by a flat ring 46. At the center of the seat element 41, there is an opening 43. A number of rib plates 42 are arranged inside the seat element 41 to intersect with each other. Their intersection is right beneath the opening 43 so that, on one hand, a vertical column 44 is supported to stand at the center of the opening 43 to extend vertically upward and, on the other hand, fluid could freely flow through the opening 43 and the intersecting rib plates 42. The seat element 41 has a diameter slightly smaller than that of the ring wall 131. Around the circumference of the seal element 41, there are a number of equal-spacing, radially extending protrusions 45 that could fit inside the vertical slots 132 and move up and down therein. As such, the engaging member 40 is allowed to move vertically inside the flange 13 and, as the engaging member 40 is pushed upward, the vertical column 44 would raise the blocking element 20.

The major characteristics of the infusion makers are as follows. The circumference of the cover 15 is extended to form a guiding plate 152 adjacent to the handle 14. A sleeve element 12 with a through hole 121 made of food-grade flexible rubber are positioned at the through hole 11 to tightly interface with the blocking element 20. The flange 13 has a larger diameter than the engaging member 40. The flange 13 has a number of foot rests 133 around its circumference for steadily supporting the infusion maker.

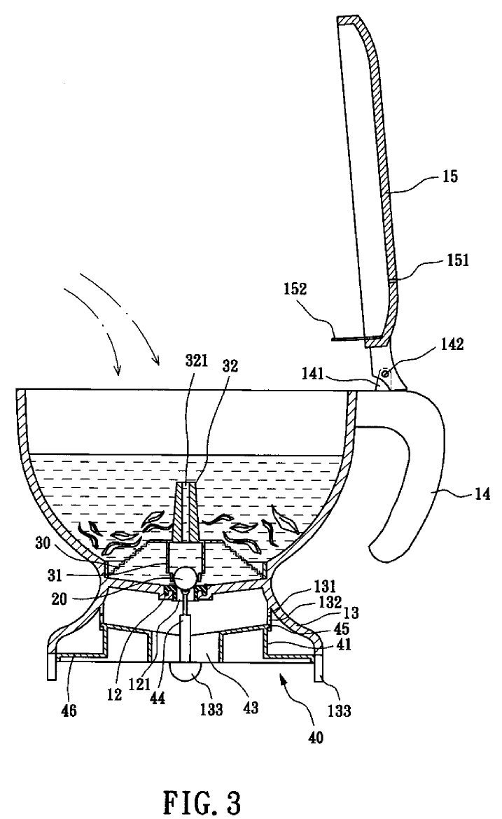

As shown in FIG. 3, the body member 10 could be reliably placed on a table top when placing coffee grounds etc. and pouring hot water inside. The engaging member 40 would naturally move downward due to the gravity. The blocking element 20 is therefore not raised by the vertical column 44 and directly block the through hole 121 of the sleeve element 12. The drink made inside the body member 10 is as such blocked.

The engaging member 40 is well protected inside the flange 13 so as to prevent the engaging member 40 from being accidentally triggered. The foot rests 133 on the other hand constitute a plane larger than the engaging member 40 so that the infusion maker would not tilt to a side. The foot rests 133 do not engage the engaging member 40 in any way and the assembly of the infusion maker is much simplified.

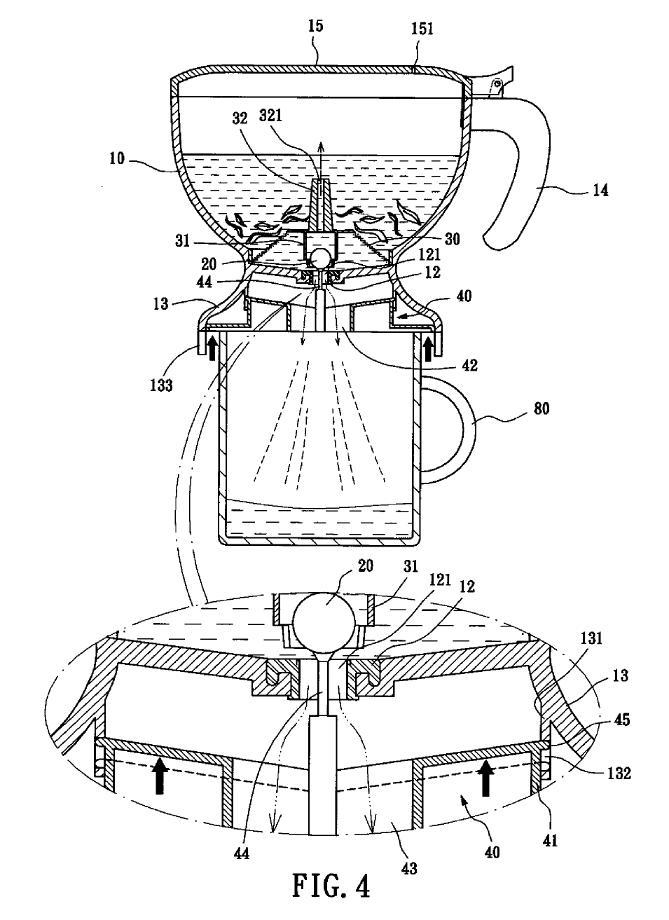

As shown in FIG. 4, when the infusion maker is placed on top of a top-opened container 80, the wall of the container 80 pushes the engaging member 40 upward and the vertical column 44 raises the blocking element 20 from the though hole 121 of the sleeve element 12. The drink made inside the body member 10 therefore could flow through the through hole 121, the engaging member 40, and then into the container 80.

It should be pointed out that the air pipe 32 with its top opening 321 provides convection to facilitate the flow of the drink. Additionally, the air pipe 32, due to its height, allows easy grasp and removal of the filter member 30 for cleaning and replacement.

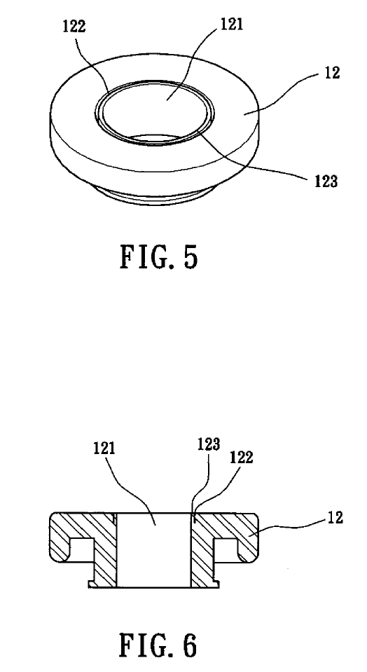

As shown in FIGS. 5 and 6, around the through hole 121, the sleeve element 12 has circular groove 122, thereby forming a thin and flexible circular wall 123. When the blocking element 20 rests on the sleeve element 12 to block a the through hole 121, the circular wall 123 is deformed to tightly and completely attach to the contour of the blocking element 20 to prevent any possible leakage.

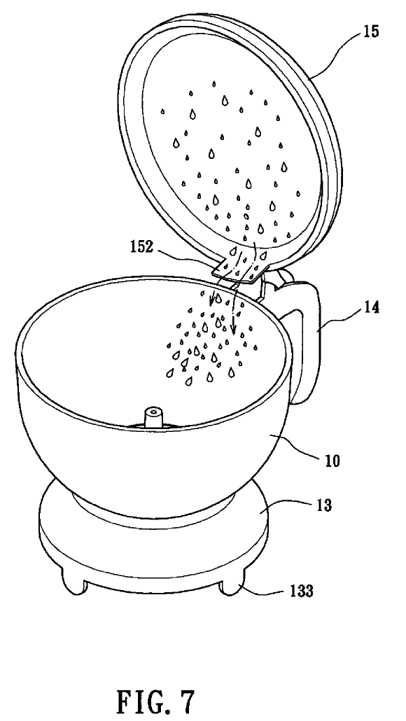

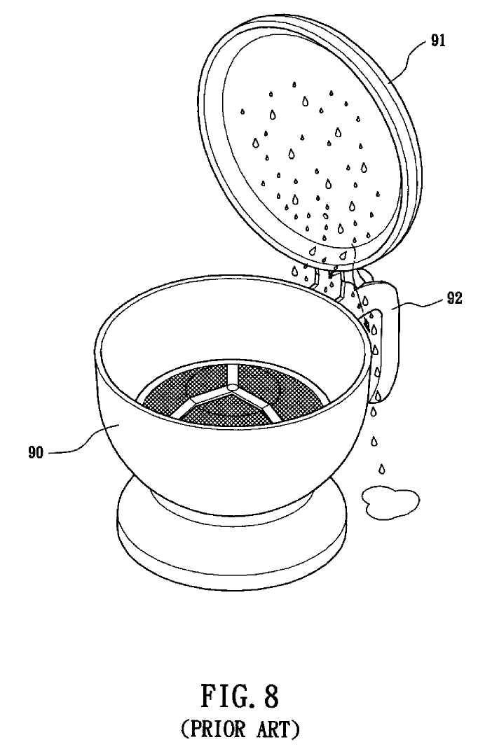

As shown in FIG. 7, when the cover 15 is opened, the water drops condensing on the inner surface of the cover 15 would follow the guiding plate 152 to flow back into the body member 10, without dripping all over the table top, making the use of the infusion maker cleaner and easier.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An infusion maker comprising:
a body member having a through hole at the bottom of said body member, a flange surrounding a lower part of said body member, and a cover hinged to said body member;
a sleeve element having a through hole positioned at said through hole of said body member;
a blocking element blocking said through hole of said sleeve element;
a filter member inside said body member covering said sleeve element and said through hole of said body member so that fluid has to flow through said filter member before flowing through said through hole of said body member;
an engaging member configured below said body member capable of moving up and down relative to said body member; wherein, said cover has a guiding plate extended from the circumference from said cover to guide condensed water drops back into said body member; said flange has a larger diameter than that of said engaging member; and said flange has a plurality of foot rests around the circumference of said flange to stably support said body member.

2. The infusion maker according to claim 1, wherein an air pipe having a through channel through said filter member is extended vertically upward from a top side of said filter member for easy grasping of said filter member and for providing convection to facilitate the flow of fluid inside said body member.

3. The infusion maker according to claim 1, wherein said sleeve element has a circular groove around said through hole of said sleeve element so as to form a thin circular wall around said through hole of said sleeve element.

4. The infusion maker according to claim 1, wherein said cover has a ventilation hole.

5. The infusion maker according to claim 1, wherein a handle is provided to a side of said body member; a pair of support element is raised from a top side of said handle where a pivot is supported therebetween; and said cover is hinged to said pivot.

6. The infusion maker according to claim 1, wherein a positioning tube is extended vertically downward from a bottom side of said filter member so as to position said blocking element right at said through hole of said body member.
